(19) United States
(12) Patent Application Publication
(10) Pub. No.: US 2022/0080717 A1
(43) Pub. Date: Mar. 17, 2022

(54) METHOD OF REDUCING ADHESIVE BUILD-UP ON EQUIPMENT SURFACES

(71) Applicant: Bostik, Inc., Wauwatosa, WI (US)

(72) Inventors: Russell P. STUCZYNSKI, Waukesha, WI (US); Katsuyuki TANAKA, Yao (JP); Xin YE, Shanghai (CN); Zhenjun ZHANG, Shanghai (CN)

(21) Appl. No.: 17/417,840

(22) PCT Filed: Dec. 19, 2019
(86) PCT No.: PCT/US2019/067536

§ 371 Date: Jun. 24, 2021

(30) Foreign Application Priority Data
Dec. 28, 2018 (CN) CN201811625604X

(51) Int. Cl. B32B 37/12; B32B 41/00; B32B 5/02; B32B 15/14; B32B 38/00

(52) U.S. Cl. CPC B32B 37/1207; B32B 41/00; B32B 5/022; B32B 2555/02; B32B 38/0012; B32B 2037/1215; B32B 15/14

(57) ABSTRACT

Build-up of adhesive on process equipment is reduced or even eliminated by increasing the running temperature of process equipment used to guide substrates as they are conveyed along a system used to apply adhesive and form laminates. Preferably, the process equipment is heated to a temperature of at least about 5° C., preferably at least about 10° C., and most preferably at least about 15° C., above the crossover temperature of the adhesive, and at most about 60° C., preferably at most about 50° C., and most preferably at most about 45° C., above the crossover temperature. This method is particularly beneficial when using hot melt adhesives to form laminates with permeable substrates, such as low basis weight nonwovens, for use in disposable absorbent articles. A system for applying a hot melt adhesive to a substrate comprises a heater for providing heat to the process equipment and, optionally, a chiller for cooling the process equipment.

### FIELD OF THE INVENTION

This invention relates to methods of fabricating laminate structures having substrates bound together by a hot melt adhesive for use in applications such as disposable absorbent articles. More specifically, this invention relates to reducing, or completely eliminating, build-up of adhesive on process equipment during such fabrication. This is particularly useful when employing hot-melt adhesives to form laminate articles with or permeable substrates, such as nonwoven substrates or perforated films.

### BACKGROUND OF THE INVENTION

Hot melt adhesives (HMAs) typically exist as solids at ambient temperature that can be converted to flowable liquids by the application of heat. The molten adhesive is applied to a substrate using a variety of application methods. A second substrate is often laminated to or within the first substrate and the adhesive solidifies upon cooling to form a strong bond. The major advantage of hot melt adhesives is the lack of a liquid carrier, as would be the case for aqueous or solvent-borne adhesives, thereby eliminating the costly drying step during application. Also, hot melt adhesives can be formulated to have relatively short open times, and thus do not require extensive curing times. In addition, hot melt adhesives typically have high “green” strength upon application. Suitable hot melt adhesives must possess the appropriate bond strength to adhere the substrates involved, and must also possess adequate flexibility, suitable viscosity, and open time to function on commercial equipment, as well as acceptable thermal stability under normal application temperatures.

Styrenic block copolymers (SBc) are commonly employed in hot-melt adhesive formulations used to produce laminate articles for a variety of end-use applications. The styrenic phase of SBc is generally considered to offer the adhesive cohesive strength while the poly(diene) segments are thought to provide the elastomeric behavior needed to withstand mechanical forces and maintain a strong bond when the laminate structures undergo various stresses in end-use applications. Styrenic polymers are glassy in nature and possess relatively high order-disorder transition points. When freshly applied, it is generally believed that the styrenic portions develop properties rapidly to provide the cohesive strength required for the adhesive to evenly wet out the surface of porous substrates without over penetration. After applying the adhesives, the first-coated layer is often next compressed with additional films and substrates to form multilayer laminate articles.

Polyolefin-based hot melt adhesives have also been used to produce laminate articles for a variety of end-use applications. U.S. Pat. No. 10,011,744, owned by the assignee of the present application, discloses a hot melt adhesive composition comprising a polymer blend based on a low molecular weight semicrystalline propylene based polymer and a high molecular weight essentially amorphous propylene based polymer. The composition further contains a compatible tackifier, a plasticizer, an antioxidant, and optionally a wax, a filler, a colorant, a UV absorber, another polymer, or combinations thereof. The hot melt adhesive composition is useful for a variety of industrial applications where bonding of low surface energy substrates is encountered, including disposable nonwoven hygienic articles, labeling and other assembly applications. Particularly preferred applications include nonwoven disposable diaper and feminine sanitary napkin construction, diaper and adult incontinent brief elastic attachment, diaper and napkin core stabilization, diaper backsheet lamination, industrial filter material conversion, and surgical gown and surgical drape assemblies.

When bonding permeable substrates, the temperatures of equipment used to convey the substrates (which are typically in the form of rolls) have traditionally been controlled to values at or below ambient temperatures in an effort to promote adhesive vitrification and reduce the potential of any exposed adhesive being transferred to process equipment. Such process equipment includes nip rollers, supporting boards, and other objects contacted by the substrates as they are conveyed. Avoiding or minimizing adhesive transfer to process equipment is critical as build-up of adhesive on equipment impedes the movement of the web along the system. Such restrictions in the web movement can lead to process instability and, in severe cases, web breaks and line outages. Cooling nip roller temperatures to prevent build-up is well known in the art. While low temperatures are accepted as a means to control build-up, nip roller temperatures are generally maintained close to ambient values based on mechanical limitations, the energy costs associated with chilling, and hygiene concerns caused by the final article picking up moisture from condensation forming on highly cooled nip rollers.

U.S. Pat. No. 5,763,333 discloses a composite sheet comprising a liquid impermeable sheet and a nonwoven fabric joined to each other by an adhesive composition. The patent discloses the problem of adhesive undesirably bleeding (or migrating) through a nonwoven substrate, which is permeable, causing the nonwoven substrate to stick to the adjacent layer of a sheet. This phenomenon, called blocking, can result in a rolled composite sheet which will be broken or cling to itself when it is unrolled. This patent describes the use of a particular nonwoven substrate along with an adhesive having certain physical properties to reduce blocking.

PCT Publication No. WO 2018/026395, owned by the assignee of the present application, discloses reducing build-up of adhesive on process equipment by increasing the running temperature of circumferential rolls (e.g., nip rollers or idlers) used to compress and adhesively bond the substrates of a laminate structure together. This method is particularly beneficial when using polyolefin-based hot melt adhesives to form laminates with permeable substrates, such as low basis weight nonwovens, for use in disposable absorbent articles. The method can be used to make a range of laminated structures, such as bilaminates and trilaminates. This patent application discloses embodiments in which the preferred temperature range of nip rollers for reducing build-up on the nip rollers is about the crossover temperature of the adhesive.

It is known that process equipment heats up during operation of a system because of friction.

### SUMMARY OF THE INVENTION

According to an embodiment of the invention, a method of operating a system for applying a hot melt adhesive comprises the steps of: heating a supporting board with a heat source, independent of friction caused by operation of the system, to a temperature sufficient to at least significantly reduce build-up of adhesive on the supporting board during operation; applying a hot melt adhesive to an adhesive-receiving surface of a permeable substrate, wherein the permeable substrate has a conveyor-facing surface opposed from the adhesive-receiving surface; and conveying the permeable substrate with the hot melt adhesive applied thereon such that the conveyor-facing surface of the permeable substrate contacts the heated supporting board as the permeable substrate is conveyed. Preferably, the heating step comprises heating the supporting board to a temperature of at least about 5° C., preferably at least about 10° C., and most preferably at least about 15° C., above the crossover temperature of the adhesive. More preferably, the heating step comprises heating the supporting board to a temperature of at most about 60° C., preferably at most about 50° C., more preferably at most about 45° C., and most preferably at most about 35° C., above the crossover temperature of the adhesive.

According to another embodiment of the invention, a system for applying a hot melt adhesive to a substrate comprises: a plurality of rollers for conveying the substrate; an adhesive applicator for applying the adhesive to the substrate; a supporting board for providing a conveying path for the substrate after the adhesive has been applied to the substrate; and a heater for providing heat to the supporting board. According to a further embodiment of the invention, the system further comprises a chiller for cooling the supporting board.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. Included in the drawing are the following figures:

FIG. 1 is a side and partial schematic view of a system for making a laminate according to an embodiment of the present invention;

FIG. 2a is top plan view of the system shown in FIG. 1 with folding arms;

FIG. 2b is a top plan view of a system similar to that shown in FIG. 1 but with no folding arms;

FIG. 3a is a top perspective view of aspects of the system shown in FIG. 1; and

FIG. 3b is a top perspective view of aspects of the system shown in FIG. 1, with a nonwoven substrate being conveyed.

### DETAILED DESCRIPTION OF THE INVENTION

The present invention is directed to methods of operating a system for applying a hot melt adhesive in a way which reduces or even fully eliminates adhesive build-up on the surfaces of equipment used for manufacturing laminates. Methods of the invention may also be viewed as methods for making a laminate. Such laminates may be incorporated into absorbent articles, such as disposable diapers, training pants, absorbent underwear, adult incontinence products, feminine hygiene products including feminine care pads and napkins, and surgical drapes. The present method reduces or eliminates adhesive build-up on process equipment when using permeable substrates, such as perforated films and low-basis weight nonwovens, to construct the laminates. Such build-up, which can result in blocking of the formed laminate, occurs by adhesive undesirably bleeding through or migrating across permeable substrates and then sticking to the process equipment during the lamination process. In an embodiment, the permeable substrate is a formed film having small holes, such as what may be used as a top sheet of a feminine care pad.

As used herein, the term “process equipment” refers to all equipment which comes into contact with any substrate as such substrate is conveyed along the system while the system is in operation. Also, “operation” of a system means a state of a system during which it is conveying substrates, applying adhesive to a substrate, and forming laminates. A “laminate” as used herein means any final product or component thereof made of at least one substrate adhered to itself by being folded over onto itself and adhered in place by a hot melt adhesive, at least two substrates being adhered to one another by being mated with a hot melt adhesive therebetween, or at least one substrate being folded around a second substrate and adhered in place by a hot melt adhesive.

The present invention may be used in connection with a wide range of systems used to make laminates using hot melt adhesives. Any system which utilizes one or more supporting boards are appropriate for use with the present invention. As used herein, the term “supporting board” refers to any process equipment that is used to convey and optionally straighten out (or “iron out”) a substrate that has been contacted with hot melt adhesive. A supporting board may be of any shape but typically is generally flat and rectangular or trapezoidal when viewed from the top of the system. A supporting board may have additional functions, such as shaping a substrate or folding the substrate either onto itself or partially or fully around another substrate. Typically, a supporting board does not have any external force applied against it in a direction normal to the plane of the supporting board, other than that caused by tension.

Embodiments of the invention described herein can be utilized with a broad range of hot melt adhesives. In particular, the invention can improve the process behavior of adhesives based on SBc, polyolefins, and ethylene vinyl acetate (EVA). It has been found that build-up of adhesive on process equipment can be reduced and even fully eliminated through judicious selection of the temperature of the supporting board, including the temperature of such equipment at start-up. As used herein, start-up is defined as the point in a process at which adhesive is first introduced to a processing line after the system has been shut down and cooled to room temperature, about room temperature, or substantially below operating temperature, such as is typically achieved in an overnight shut-down. In a preferred embodiment of the invention, the heating step is done prior to start-up of operation of the system, such that, before start-up, the desired temperature (as described herein) of the supporting board is achieved.

This method is particularly beneficial when using hot melt adhesives to form laminated structures with permeable substrates, such as low basis weight nonwovens or perforated films. As used herein, a “permeable substrate” is one which allows for an undesirable amount of build-up on circumferential rolls at room temperature based on the given operating conditions and adhesive selected. As will be demonstrated below, careful selection of process conditions based on rheological properties of the adhesive can be applied in a general sense to limit adhesive build-up, as explained herein and as shown in the examples. The inventive method does not negatively impact manufacturing costs and eliminates moisture/condensation concerns using highly chilled rollers. Using this method, process equipment temperatures can be set to increase bonding or maintain target values at lower adhesive add-on.

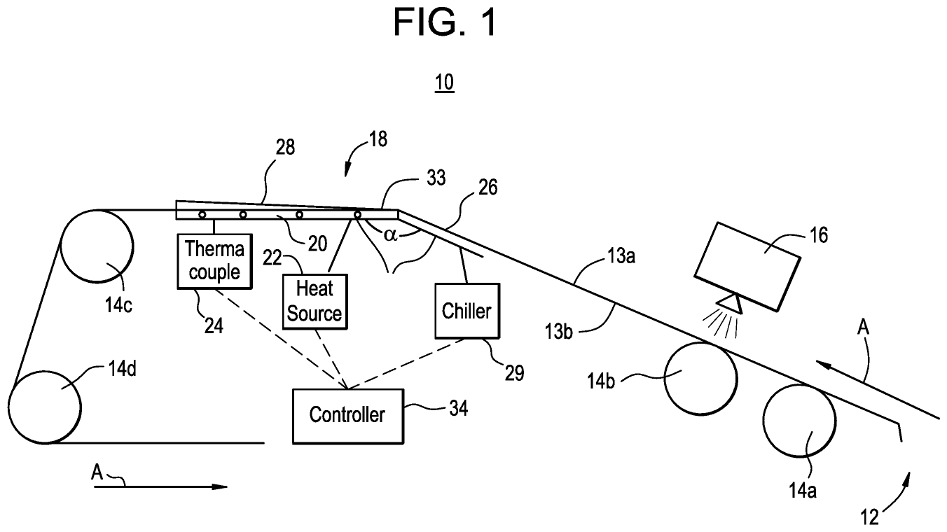

As shown in FIG. 1, a system 10 for applying a hot melt adhesive to a substrate 12 comprises: a plurality of rollers 14a-14d for conveying the substrate; an adhesive applicator 16 for applying the adhesive to the substrate; a supporting board 18 for providing a conveying path for the substrate after the adhesive has been applied to the substrate; and a heater 20 for providing heat to the supporting board. Substrate 12, which may be a permeable substrate such as a nonwoven substrate including those used in a diaper, has an adhesive-receiving surface 13a and a conveyor-facing surface 13b opposed from the adhesive-receiving surface. Adhesive applicator 14 applies hot melt adhesive to adhesive-receiving surface 13a of substrate 12 in a known way. For example, contact coating applicators such as slot coating and non-contact coating applicators such as controlled fiberization, random fiberization, and curtain coating, may be used. Heater 20 may be any conventional heater and may be powered by a heat source 22. For example, heat source may be a source of gas or electric heat, and heater 20 may include a cartridge or platform for distributing the heat evenly along supporting board 18.

In operation, a method of applying a hot melt adhesive in a system 10, comprises the steps of: heating supporting board 18 with a heater 20, independent of friction caused by operation of the system, to a temperature sufficient to at least significantly reduce build-up of adhesive on the supporting board during operation; applying a hot melt adhesive to adhesive-receiving surface 13a of a permeable substrate 12, wherein the permeable substrate has a conveyor-facing surface 13b opposed from the adhesive-receiving surface; and conveying the permeable substrate with the hot melt adhesive applied thereon such that the conveyor-facing surface of the permeable substrate contacts the heated supporting board as the permeable substrate is conveyed.

As explained in the examples below, in some systems, adhesive builds up on the process equipment on the side of a permeable substrate opposite to which adhesive is applied. It has been discovered that the build-up can be reduced and substantially eliminated by heating the process equipment to a temperature approximately between 5° C. and 60° C. above the crossover temperature of the adhesive, as described below. Preferably, the selected temperature reduces build-up of adhesive on supporting board 18 during operation such that less than 3% of the products produced by the laminating line are defective due to blocking. More preferably, the selected temperature achieves less than 1% of the products produced by the laminating line being defective due to blocking. In one embodiment, the temperature sufficient to at least significantly reduce build-up of adhesive on the supporting board during operation means that at least 90% (preferably 95%, more preferably 99%, and most preferably 99.5%) less adhesive builds up on the supporting board when compared with the same system with all conditions identical other than the supporting board is at room temperature. As explained below, appropriate temperatures suitable for heating of the supporting board can be at least about 80° C. or higher, more preferably about 85° C., and most preferably about 90° C. or higher.

Another way of identifying the desired temperature of the supporting board is to identify the temperature of the supporting board in terms of the crossover temperature of the adhesive (referred to herein as the crossover temperature or the rheological crossover, Tx, of the adhesive). The supporting board is preferably controlled to a temperature of between at least about 5° C. above and at most 60° C. above the crossover temperature of the adhesive, preferably between at least about 10° C. above and at most about 50° C. above the crossover temperature of the adhesive, and most preferably at least about 15° C. above and at most about 45° C. above the crossover temperature of the adhesive. When a number of lower and upper limits of a property or characteristic are provided herein, the invention contemplates a range extending from any listed lower limit to any listed upper limit, such as from at least about 10° C. above to at most about 30° C. above the crossover temperature of the adhesive. The Tx is defined as the highest temperature at which the storage modulus, G′, and loss modulus, G″, intersect as measured using dynamic mechanical analysis (DMA) of the adhesive while cooled from the molten to solid state. The test method used is ASTM D 4440-01, with a cooling rate of 10° C./min.

The upper limit of the temperature of the supporting board may vary over a wide range and may be dictated by the decomposition temperature of the adhesive or simply by cost (i.e., heating the supporting board to temperatures above that which is needed to attain the effects of the invention is undesirable and unduly costly). Exemplary upper limits include +60° C. of the Tx, more preferably +50° C. of the Tx, even more preferably +45° C. of the Tx, still more preferably +40° C. of the Tx, and most preferably +35° C. of the Tx. Likewise, if a second supporting board is used, then it may be heated to any temperature range as described herein.

When referring to the temperature of the supporting board or any process equipment mentioned herein, the relevant specific part of such components is the surface of the process equipment which comes into contact with the permeable substrate as it is being conveyed. Conventional methods for determining temperature of the surface of the process equipment can be employed, such as by use of one or more thermocouples. In addition, conventional ways of heating the process equipment may also be employed, such as by using an external heat source 22. As shown in FIG. 1, heat source 22 is independent of friction caused by operation of the system.

As shown in FIG. 1, adhesive applicator 16 applies a hot melt adhesive to adhesive-receiving surface 13a of permeable substrate 12, wherein the permeable substrate has a conveyor-facing surface 13b opposed from the adhesive-receiving surface. In an embodiment of the invention, the hot melt adhesive is applied at an add-on level of from about 0.5 to about 175 grams per square meter (“gsm”). In one embodiment, the hot melt adhesive is applied at an add-on level of from about 1 to about 35 gsm, preferably from about 2 to about 20 gsm. In another embodiment, the hot melt adhesive is applied at an add-on level of from about 100 to about 175 gsm, preferably from about 130 to about 160 gsm; this embodiment may be especially applicable for an adhesive which can serve as an adhesive-based stretchable component. Substrate 12, with the hot melt adhesive applied thereon, is conveyed to supporting board 18 such that conveyor-facing surface 13b of permeable substrate 12 contacts the heated supporting board as the permeable substrate is conveyed. By having heated supporting board 18 to the temperatures specified above, build-up of adhesive on the supporting board is reduced or even entirely eliminated.

In the embodiment shown in the figures, supporting board 18 comprises a landing segment 26 and a conveying segment 28. Landing segment 26 and conveying segment 28 form an obtuse angle α and provide a conveying path for permeable substrate 12. Landing segment 26 and conveying segment 28 intersect at inflection line 33, where the slope of the conveying path decreases from the slope of landing segment 26 to that of conveying segment 28. In the embodiment shown, conveying segment 28 comprises folding arms 30a and 30b, which cause the permeable substrate to fold over on itself to provide a laminate. In other embodiments, the conveying segment could have one or no arms, or could have other features to impart a variety of shapes to the permeable substrate. The material of supporting board 18 may vary over a wide range and may be metal, including aluminum and stainless steel.

When system 10 is used to make an elastic leg cuff of a diaper, the permeable substrate is a nonwoven substrate and the method further comprises positioning an elastic strand on the nonwoven substrate at a location corresponding to the fold of the laminate formed by folding arms 30a, 30b. In other words, the elastic strand is positioned along the fold lines at the lateral, outer edge of conveying segment 28. Adhesive may be applied to permeable substrate 12, the elastic strand, or both. Folding arms would serve to partially encompass first substrate 12 around the elastic strand.

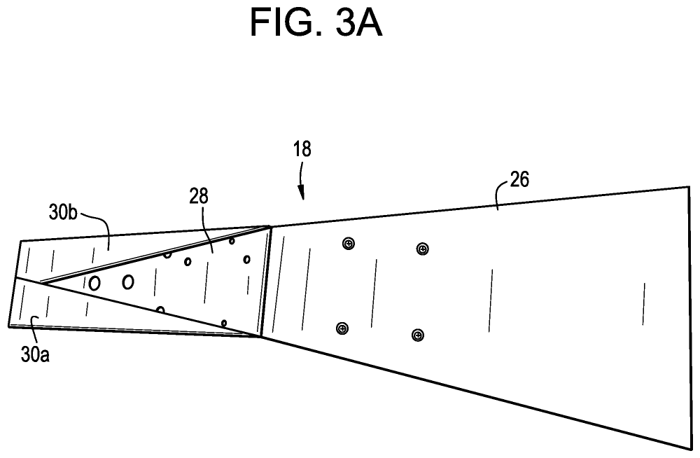

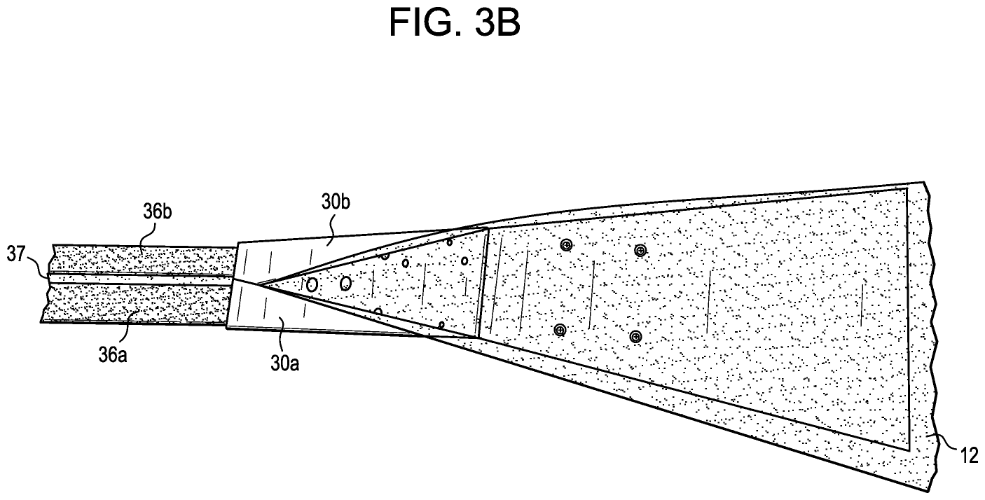

FIGS. 3a and 3b show in more detail how folding arms 30a, 30b serve to fold a non-woven substrate over on itself. As shown in FIG. 3a, supporting board 18 comprises a landing segment 26 and a conveying segment 28, and conveying segment 28 serves as a folding board as it has folding arms 30a and 30b. Viewed looking down on system 10, folding arms 30a and 30b have the shape of a right triangle with the two edges forming the right triangle disposed along the trailing edge of conveying segment 28 and a lateral edge of conveying segment 28. Folding arms 30a and 30b are elevated slightly relative to conveying segment 28, such that a recess is formed between the facing surfaces of the folding arms and the conveying segment. Substrate 12 is shown in FIG. 3b and is moving in the direction of arrow A when the system is in operation. As can be seen in FIG. 3b, as substrate 10 moves over inflection line 33, part of the substrate begins to be pinched under the recess defined by the facing surfaces of folding arms 30a and 30b and conveying segment 28. The tension on substrate 10 contributes to this pinching. As substrate 10 travels along conveying segment 28, more of the substrate is folded under and then caused to become bonded to itself by virtue of adhesive which had been applied upstream of the views shown in FIGS. 3a and 3b. As substrate 10 exits the downstream end of conveying segment 28, the recess defined the facing surfaces of folding arms 30a and 30b and conveying segment 28 is narrowed to cause further compression on the folded over portions of the substrate, thereby causing the substrate to better bond to itself. As can be seen in FIG. 3b, substrate 10 exiting supporting board 18 has dual layer portions 36a and 36b and single layer portion 37. Substrate 10 folded over on itself to form dual layer portions 36a and 36b; the design of this substrate was intended to have a portion which remained only as a single layer, namely single layer portion 37.

The adhesive is typically heated to become molten. The degree to which the adhesive is heated depends on a number of conditions, including the rheological properties of the adhesive, the conditions of the system, and the desired properties. One way to view the desired temperature of the adhesive is to determine the desired viscosity of the adhesive as it leaves the applicator. In embodiments of the invention, the adhesive is heated to a temperature to provide a viscosity of at least about 500 cPs, more preferably at least about 1,500 cPs, still more preferably at least about 2,500 cPs, and most preferably at least about 3,000 cPs, and at most about 35,000 cPs, more preferably at most about 20,000 cPs, still more preferably at most about 10,000 cPs, and most preferably at most about 6,000 cPs.

According to an embodiment of the invention, a temperature monitor, such as thermocouple 24, is used to detect the surface temperature of supporting board 18. Generally, this permits monitoring the temperature of supporting board 18 during operation. This embodiment further comprises transferring heat or a cooling medium to control the temperature of the supporting board within the desired range mentioned herein. As shown in FIG. 1, the system further comprises a chiller 29 for cooling the supporting board. FIG. 1 also shows a heat control system 34 which responds to signals from thermocouple (or sensor) 24 and actuates heat source 22 or chiller 29 for transferring heat among the heater, the chiller, and the supporting board to maintain the temperature of the supporting board between at least about 5° C. above and at most 60° C. above the crossover temperature of the adhesive, preferably between at least about 10° C. and at most about 50° C. above the crossover temperature of the adhesive, and more preferably at least about 15° C. above and at most about 45° C. above (most preferably at most about 35° C.) above the crossover temperature of the adhesive. In the embodiment shown, only one heat sensor is used, but multiple sensors could be used. Also, heat control system 32 and the heater 20 and chiller 29 could apply heat to maintain a constant temperature of supporting board 18 along its length (i.e., its dimension in the direction of travel along arrow ‘A’ of permeable substrate 12). Alternatively, the heat control system 34 could function to provide an array of temperatures along the length of supporting board 18, such as an array of temperatures which decreases along its length in the direction of travel corresponding to the reduction of temperature of the adhesive.

Regardless of the system configuration that is employed, this method is suitable for use with a wide range of adhesives, including commercial adhesives based on SBc, polyolefins, and EVA polymers (or mixtures thereof) as are well-known in the art. It is especially useful when bonding low-basis weight permeable substrates. It is further beneficial to employ this inventive method when using hot-melt adhesives containing semi-crystalline polymers that display low glass transition values where low glass transition values are defined as being below 35° C. The semi-crystalline polymer used in embodiments of the hot melt adhesive composition is preferably a polyolefin or polyolefin blend. The polyolefin or polyolefin blend is more preferably selected from the group consisting of homopolymers, copolymers and terpolymers derived from ethylene, propylene, 1-butene, 1-hexene, 1-octene and combinations thereof. The most preferred polyolefin is an ethylene-based copolymer or a propylene-based copolymer.

More generally, the invention is suitable on a wide range of adhesives, including those based on polyolefins. Such adhesives can utilize a single polyolefin or, more preferably, mixtures of polyolefins. Especially well-suited polyolefins include those generated from ethylene and propylene. In the case of polyethylene systems, those containing α-olefin comonomers such as 1-butene, 1-hexene, 1-octene and/or the like which serve to disrupt polymer crystallinity can be used to produce adhesives that melt readily and can easily be applied via numerous coating methods. Generally, medium density (0.940-0.915 g/mL) and linear low-density (<0.915 g/mL) ethylene-based polymers are suitable for such applications though low molecular weight, higher density polyethylene can be employed provided they display adequate melt compatibility. Branched low-density polyethylenes referred to as low-density polyethylene (LDPE) may also be used. The ethylene-based copolymers may have the comonomer units randomly distributed as is common in medium-density polyethylenes, low-density polyethylenes (LDPE), and linear-low-density polyethylene (LLDPE). Conversely, olefin block copolymers where the comonomer is present in different concentrations in discrete segments of the polymer chain may be also employed. The polyethylene backbone may be highly linear or contain some or many long-chain branches.

Adhesives consisting of propylene-based polymers and copolymers can also be used with the current invention. Suitable polypropylene species include isotactic, syndiotactic, and atactic propylene homopolymers or copolymers. Polypropylenes designed to possess a controlled level of stereoerrors to modulate the melting behavior and mechanical properties can also be employed as required to for the bonding application. Propylene based copolymers and terpolymers that can also be employed as components in adhesives for the current invention include those with relatively low levels (<5 mole %) of ethylene, 1-butene, and/or higher α-olefin comonomer which are commonly referred to as random copolymers. These include poly(propylene-co-olefin) copolymers and terpolymers with relatively high crystallinity that display melting points in the range of 130 to 165° C. Propylene based copolymers and terpolymers with relatively high levels (>5 mole %) of ethylene, 1-butene, and/or higher α-olefin comonomer can also be employed as components in adhesives for the current invention.

Additionally, heterophasic polypropylenes commonly referred to as impact copolymers (ICP) that contain a rubbery ethylene-propylene or ethylene-propylene-1-butene polymer phase within a polypropylene or propylene copolymer matrix may also be employed. Propylene polymers suitable for the present invention may be reactor grade materials or controlled rheology polymers produced via chain scission methods commonly practiced in the commercial production.

In addition to ethylene and propylene polymers, materials commonly referred to as amorphous poly-α-olefins, APAO, may also be employed. APAO polymers are selected from the group consisting of propylene-ethylene copolymer, propylene-1-butene copolymer, and terpolymers of propylene, ethylene, and 1-butene.

In addition to these polymers, such adhesives may include: a tackifying agent; a plasticizer; a stabilizer or antioxidant; and additives including waxes, surfactants, fillers, nucleation packages, and/or other auxiliary components as required to adjust properties for end-use performance. Some well-suited polyolefin-based adhesives for use in the present invention may be those described in U.S. Patent Publication No. 2016/0102230, incorporated herein by reference. The adhesives described therein employ mixtures of polypropylene copolymers, polyolefin elastomers, and amorphous polyolefins. These adhesives exhibit excellent flow allowing them to evenly coat (“wet out”) substrates yet form strong initial bonds that are maintained upon long-term aging, making them useful for hygiene, construction, and packaging applications. Other adhesives that may be well-suited for use in the invention include those described in U.S. Pat. No. 9,670,388, which is directed to a hot melt adhesive having (i) an amorphous polyolefin copolymer composition comprising propene monomer units and at least about 40 wt. % of 1-butene monomer units; and (ii) heterophase polyolefin propylene copolymer composition comprising propene comonomer units and a comonomer unit selected from the group consisting of ethylene, 1-hexene, and 1-octene, and amorphous blocks and crystalline blocks.

Other adhesives that may be suitable for use with the present invention are described in U.S. Patent Publication Nos. 2016/0177142, 2018/0148616, and 2016/0121014; and U.S. Patent Application Nos. 62/624,369 and Ser. No. 16/157,190; all of which are incorporated herein by reference.

The method is very effective in reducing or preventing equipment build-up when employing permeable substrates such as nonwovens and perforated films (including screens) used in laminate structures. The invention is suitable for any substrate that may permit adhesive to bleed through or migrate across the substrate to the other side (i.e., from the adhesive-receiving surface to the conveyor-facing surface). Most preferably, the permeable substrate is a low basis weight nonwoven, which is also porous. By “low basis weight,” it is meant a nonwoven that has a basis weight below about 60 grams per square meter (gsm). In some embodiments, the nonwoven has a basis weight below about 50 gsm, and even more preferably below about 40 gsm. In other embodiments, the nonwoven has a basis weight of between about 2 and about 30 gsm and more preferably between about 2 to about 20 gsm. Basis weights on the higher end of this scale, for example between about 20 and about 30 gsm, may be used with the higher add-on weights of adhesive mentioned above, such as from about 100 to about 175 gsm, preferably from about 130 to about 160 gsm.

In the embodiment shown, permeable substrate 12 with the hot melt adhesive applied thereon is conveyed, after it has contacted the supporting board, to a nip roller 14c. Preferably, the nip roller is heated to a temperature sufficient to at least significantly reduce build-up of adhesive on the nip roller as described in PCT Publication No. 2018/026395, incorporated herein by reference. Preferably, the nip roller is heated to a temperature of at least about 30° C., preferably at least about 20° C., and most preferably at least about 10° C., below the crossover temperature of the adhesive and at most about 30° C., preferably at most about 20° C., most preferably at most about 10° C., above the crossover temperature of the adhesive. The temperature of nip roller 14c may be monitored during operation and heat or a cooling medium may be applied to control the temperature of the nip roller to the desired temperature. In a preferred embodiment, the heating step of nip roller 14c is done prior to start-up of operation of the system, such that the desired temperature of the nip roller is achieved before any adhesive is applied to permeable substrate 12. Although discussed in connection with nip roller 14c, the heating step may be done to other rollers in the system, such as nip roller 14d.

Although not shown in the figures, other substrates can be combined with the laminate formed by system 10. For example, a backing layer, such as non-permeable polyethylene may be applied to the folded laminate of nonwoven and elastic strand formed by system 10. Typical bilaminate or trilaminate products which might be formed according to this process are stretchable laminates for diaper, training pants, feminine care products, or adult incontinence side panels. In some products, the various substrates may be nonwoven substrates, elastic strands or panels, or elastomeric films.

Embodiments of the invention encompass various modifications to the systems shown in the figures. For example, the various rollers 14a-14d may serve to drive the substrates as conveyors. As discussed above, a primary benefit of the invention is eliminating or reducing build-up of adhesive on process equipment associated with permeable substrates. Viewed another way, the invention also permits a greater downward force normal to direction of travel A to be exerted on the substrates with the same extent of build-up resulting from a lesser downward force. Thus, a greater bond strength could be achieved or an equal bond strength but a lower add-on weight could be used.

Embodiments of the present invention provide methods for making a laminate structure, such as a bilaminate or trilaminate. The method reduces or eliminates adhesive build-up on equipment when using adhesive materials, especially those that display low glass transition temperatures (Tg), notably those with Tg values below 35° C. It is of particular utility when using semi-crystalline-based hot melt adhesives to join permeable or porous substrates in laminate structures or to adhere a single substrate to itself by folding it over and contacting the inner surfaces of the folded portion with the adhesive.

According to an embodiment of the invention, the temperature of nip roll 14c is monitored during operation. Based on the feedback from the monitoring, the amount of heat applied to roll 14c is controlled to ensure that the desired temperature or temperature range is maintained.

An aspect of the invention is a method for making a hygiene article, such as a diaper or a feminine care pad, comprising the method of operating a system for applying a hot melt adhesive as described herein. In such an aspect, the method of operating a system for applying a hot melt adhesive makes a laminate used as part of a hygiene article.

### ASPECTS OF THE INVENTION

Aspect 1. A method of operating a system for applying a hot melt adhesive, comprising the steps of:

heating a supporting board with a heat source, independent of friction caused by operation of the system, to a temperature sufficient to at least significantly reduce build-up of adhesive on the supporting board during operation;

applying a hot melt adhesive to an adhesive-receiving surface of a permeable substrate, wherein the permeable substrate has a conveyor-facing surface opposed from the adhesive-receiving surface; and

conveying the permeable substrate with the hot melt adhesive applied thereon such that the conveyor-facing surface of the permeable substrate contacts the heated supporting board as the permeable substrate is conveyed.

Aspect 2. The method of aspect 1, wherein the heating step comprises heating the supporting board to a temperature of at least about 5° C., preferably at least about 10° C., and most preferably at least about 15° C., above the crossover temperature of the adhesive.

Aspect 3. The method of aspects 2 or 3, wherein the heating step comprises heating the supporting board to a temperature of at most about 60° C., preferably at most about 50° C., more preferably at most about 45° C., and most preferably at most about 35° C., above the crossover temperature of the adhesive.

Aspect 4. The method of any of aspects 1-3, wherein the adhesive is heated to a temperature to provide a viscosity of at least about 500 cPs, more preferably at least about 1,500 cPs, still more preferably at least about 2,500 cPs, and most preferably at least about 3,000 cPs, and at most about 35,000 cPs, more preferably at most about 20,000 cPs, still more preferably at most about 10,000 cPs, and most preferably at most about 6,000 cPs.

Aspect 5. The method of any of aspects 1-4, wherein the supporting board comprises a landing segment and a conveying segment, wherein the landing segment and the conveying segment form an obtuse angle and provide a conveying path for the permeable substrate.

Aspect 6. The method of aspect 5, wherein the conveying segment comprises folding arms for causing the permeable substrate to fold over on itself to provide a laminate.

Aspect 7. The method of aspect 6, wherein the permeable substrate is a nonwoven substrate and the method further comprises positioning an elastic strand on the nonwoven substrate at a location corresponding to the cuff.

Aspect 8. The method of any of aspects 1-7, wherein the supporting board is metal.

Aspect 9. The method of any of aspects 1-8 further comprising monitoring the temperature of the supporting board during operation and applying heat or a cooling medium to control the temperature of the supporting board.

Aspect 10. The method of aspect 9, wherein the step of applying heat or cooling medium comprises controlling the temperature of the supporting board to a temperature of at least about 5° C., preferably at least about 10° C., and most preferably at least about 15° C., above the crossover temperature of the adhesive and at most about 60° C., preferably at most about 50° C., more preferably at most about 45° C., and most preferably at most about 35° C., above the crossover temperature of the adhesive.

Aspect 11. The method of any of aspects 1-10, wherein the hot melt adhesive is polyolefin-based.

Aspect 12. The method of any of aspects 1-10, wherein the hot melt adhesive is styrene block copolymer-based.

Aspect 13. The method of any of aspects 1-12, wherein the permeable substrate is a nonwoven substrate.

Aspect 14. The method of any of aspects 1-13, wherein the hot melt adhesive is applied at an add-on level of from about 0.5 to about 20 grams per square meter.

Aspect 15. The method of any of aspects 1-14, wherein the heating step is done prior to start-up of operation of the system.

Aspect 16. The method of any of aspects 1-15 further comprising conveying the permeable substrate with the hot melt adhesive applied, after it has contacted the supporting board, to a nip roller, wherein the nip roller is heated to a temperature sufficient to at least significantly reduce build-up of adhesive on the nip roller.

Aspect 17. The method of aspect 16, wherein the nip roller is heated to a temperature of at least about 30° C., preferably at least about 20° C., and most preferably at least about 10° C., below the crossover temperature of the adhesive and at most about 30° C., preferably at most about 20° C., and most preferably at most about 10° C., above the crossover temperature of the adhesive.

Aspect 18. The method of aspect 17 further comprising monitoring the temperature of the nip roller during operation and applying heat or a cooling medium to control the temperature of the nip roller.

Aspect 19. The method of any of aspects 16-18, wherein the heating step of the nip roller is done prior to start-up of operation of the system.

Aspect 20. A system for applying a hot melt adhesive to a substrate comprising:

a plurality of rollers for conveying the substrate;

an adhesive applicator for applying the adhesive to the substrate;

a supporting board for providing a conveying path for the substrate after the adhesive has been applied to the substrate; and

a heater for providing heat to the supporting board.

Aspect 21. The system of aspect 20 further comprising a chiller for cooling the supporting board.

Aspect 22. The system of aspect 21 further comprising a sensor for sensing the temperature of the supporting board and a heat control system for transferring heat among the heater, the chiller, and the supporting board to maintain the temperature of the supporting board between at least about 5° C. above and at most 60° C. above the crossover temperature of the adhesive, preferably between at least about 10° C. and at most about 50° C. above the crossover temperature of the adhesive, and most preferably at least about 15° C. above and at most about 45° C. above the crossover temperature of the adhesive.

### EXAMPLES

The following provides examples of the use of increased supporting board temperatures to mitigate build-up of adhesive on process equipment.

Dynamic mechanical analysis was performed on the various hot melt adhesives used in the examples below. A Rheometrics Dynamic Mechanical Analyzer (Model RDA III) was used to obtain the elastic (G′) and loss (G″) moduli for the adhesives as a function of temperature. Analyses were performed using 25 mm diameter parallel plates separated by a 1.6 mm gap. The adhesive sample was loaded and then heated from 140 to 170° C. at a rate of 10° C. per minute. The convection oven containing the sample was flushed continuously with nitrogen throughout the testing. The frequency was maintained at 10 rad/s, and the storage modulus (G′) and the loss modulus (G″) were calculated from the torque and strain data, which were collected as the sample was decreased 10° C./min. The crossover temperature, Tx, is defined as the maximum temperature where G′ and G″ intersect. The glass transition temperature, Tg, is defined as the maximum value of the tan □ (G″/G′) curve below the crossover temperature.

### Substrates:

Using a system similar to that shown in the figures, a bi-laminate article was made consisting of a nonwoven (spunbond nonwoven 13 gsm) folded over onto itself as shown in FIG. 3b. Upstream of FIG. 3b, an applicator applied an add-on level of adhesive of about 5 gsm and the system had a line speed of 300 mpm.

### Hot Melt Adhesives

The Example 1 test series employed Adhesive A, which is a commercial SBc-based hot melt adhesive available from Bostik (Shanghai) Management Co., Ltd. of Shanghai, China. Adhesive A has a Ring and Ball Softening Point (“RBSP”; ASTM method E28-99) of 90° C. and a Brookfield viscosity (ASTM D 3236-88) of 4,350 cPs at 125° C. In DMA testing, Adhesive A displays a glass transition temperature, Tg, of 12° C. and a crossover temperature, Tx, of 55° C.

The Example 2 test series employed Adhesive B, which is a commercial EVA-based hot melt adhesive available from Bostik (Shanghai) Management Co., Ltd. of Shanghai, China that has a RBSP of 78° C. and a Brookfield viscosity of 4,100 cPs at 140° C. In DMA testing, Adhesive B displays a Tg of 16° C. and a Tx of 75° C.

The Example 3 test series employed Adhesive C, which is a commercial SBc-based hot melt adhesive available from Bostik (Shanghai) Management Co., Ltd. of Shanghai, China that has a RBSP of 80° C. and a Brookfield viscosity of 5,137 cPs at 125° C. In DMA testing, Adhesive C displays a Tg of 16° C. and a Tx of 80° C.

The adhesives were heated to the temperatures shown on Table 1 below and the supporting board, which was stainless steel, was heated, before start-up, to the temperatures shown in Table 1 for a variety of tests for Adhesives A, B, and C. The air pressure for each test was 0.75 bar and the gun height of the Omega system was 25 mm for each test. After coating the nonwoven with adhesive for 4 minutes, the runs were stopped and the supporting boards were closely inspected. Initial bond strengths were qualitatively determined and the spooled rolls of bilaminates were examined for signs of blocking (i.e., inter-laminate bonding resulting from bleed through of adhesive during processing).

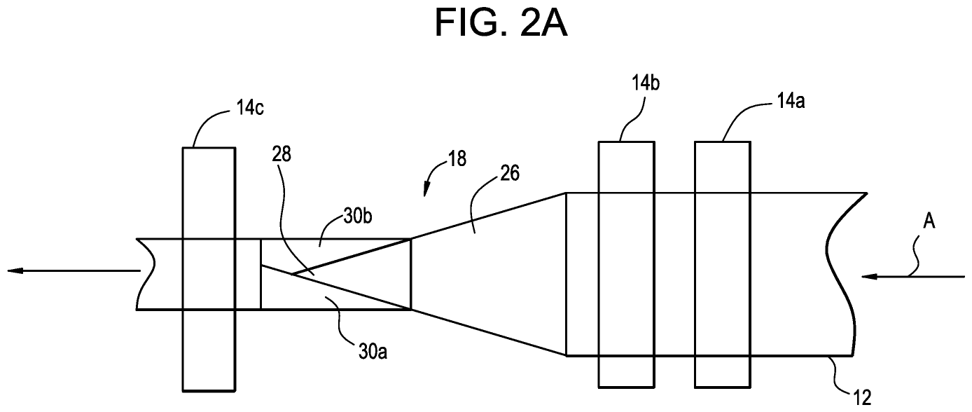

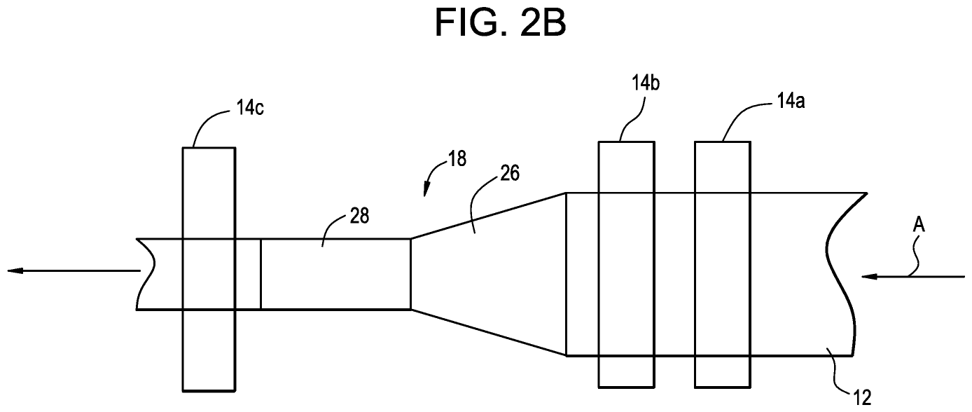

The system used in the process had folding arms 30a, 30b, as shown in FIGS. 2a, 3a, and 3b which caused the nonwoven substrate to fold over on itself. As the nonwoven substrate passed across supporting board 18, the adhesive which bled through (i.e., penetrated across) the nonwoven substrate could potentially build-up on the surface of the supporting board 18 generally, and especially at the fold lines and along inflection line 33 which forms the obtuse angle α between landing segment 26 and conveying segment 28. It was found that heating supporting board 18 to the desired temperatures did not eliminate the bleed through effect but did eliminate or significantly reduce the adhesive build-up on the supporting board.

After coating the nonwoven with adhesive for 4 minutes, the intensity of the adhesive build-up on the supporting board 18 was evaluated visually and given by a quantitative scale of zero to five, with “zero” meaning no visible adhesive build-up on the sailor board (and none evidenced by touch) and five meaning adhesive build-up at a level of at least about 90% of the surface area immediately adjacent the inflection line 33 of the supporting board. Ratings of 1-4 were assigned at generally evenly-spaced intervals with the higher score representing more build-up. Ratings of 1 or zero are commercially acceptable scores, meaning that systems could be operated at these conditions at commercial scale without appreciably compromising product quality or yield or causing unacceptable downtime due to substrate breakage caused by adhesive build-up. Runs were performed at several supporting board temperatures for each adhesive to determine the role of this variable on build-up performance Results are summarized below in Table 1:

TABLE 1

| | | Adhesive | Hot Air | Temp. of | |
|---|---|---|---|---|---|
| Test | Adhesive | Temp | Temp | support board | Bleed through |
| No. | HMA | ° C. | ° C. | ° C. | Score |
| 1 | A | 126 | 126 | 80 | 2 |
| 2 | | 126 | 126 | 85 | 1 |
| 3 | | 126 | 126 | 90 | 0 |
| 4 | | 126 | 126 | 95 | 0 |
| 5 | B | 140 | 140 | 80 | 5 |
| 6 | | 140 | 140 | 82 | 4 |
| 7 | | 140 | 140 | 86 | 3 |
| 8 | | 140 | 140 | 95 | 1 |
| 9 | | 140 | 140 | 103 | 0 |
| 10 | C | 129 | 129 | 80 | 5 |
| 11 | | 129 | 129 | 100 | 1 |
| 12 | | 129 | 129 | 105 | 0.5 |

According to the test results, as the supporting board is heated to a higher temperature, less adhesive build-up occurred. Without being bound by any theory, the reason for this effect might be because the higher temperature of the supporting board would tend to soften the adhesive built up initially on the supporting board, rendering the adhesive to be more likely to selectively remain with the nonwoven substrate instead of building up on the supporting board.

Turning more specifically to the Example 1 test series of Adhesive A, an SBc-based hot melt adhesive, one can see that acceptable build-up scores of 1 or zero were attained when the temperature of the supporting board was increased to 85° C. or above. The trend of scores shows an improvement in build-up scores from the worst score for this series of 2 at 80° C. to the best score of zero at 90° C. and 95° C. Given that the crossover temperature of Adhesive A is 55° C., it can be seen that an acceptable score of 1 was achieved at a temperature of 30° C. above the crossover temperature and the best score of zero was achieved at temperatures of 35° C. or 40° C. above the crossover temperature. No further testing at higher temperatures was conducted as it would not be desirable to heat the supporting board unnecessarily.

Turning to the Example 2 test series of Adhesive B, an EVA-based hot melt adhesive, one can see that the acceptable build-up scores of 1 or zero were attained when the temperature of the supporting board was increased to 95° C. or above. The trend of scores shows an improvement in build-up scores from the worst score of 5 at 80° C. to the best score of zero at 103° C. Given that the crossover temperature of Adhesive B is 75° C., it can be seen that an acceptable score of 1 was achieved at a temperature of 20° C. above the crossover temperature and the best score of zero was achieved at a temperature of 23° C. above the crossover temperature. No further testing at higher temperatures was conducted as it would not be desirable to heat the supporting board unnecessarily.

Turning to the Example 3 test series of Adhesive C, an SBc-based hot melt adhesive, one can see that the acceptable build-up scores of 1 or 0.5 were attained when the temperature of the supporting board was increased to 100° C. or above. The trend of scores shows an improvement in build-up scores from the worst score of 5 at 80° C. to the best score for this series of 0.5 at 105° C. Given that the crossover temperature of Adhesive C is 80° C., it can be seen that an acceptable score of 1 was achieved at a temperature of 20° C. above the crossover temperature and the best score for this series of 0.5 was achieved at a temperature of 25° C. above the crossover temperature. No further testing at higher temperatures was conducted as it would not be desirable to heat the supporting board unnecessarily.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention. Certain ranges or numerical limits are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number, and thus will typically refer to a number or value that is 10% below or above the specifically recited number or value.

1. A method of operating a system for applying a hot melt adhesive, said method comprising the steps of:
heating a supporting board with a heat source, independent of friction caused by operation of the system, to a temperature sufficient to at least significantly reduce build-up of adhesive on the supporting board during operation;
applying a hot melt adhesive to an adhesive-receiving surface of a permeable substrate, wherein the permeable substrate has a conveyor-facing surface opposed from the adhesive-receiving surface; and
conveying the permeable substrate with the hot melt adhesive applied thereon such that the conveyor-facing surface of the permeable substrate contacts the heated supporting board as the permeable substrate is conveyed.

2. The method of claim 1, wherein the heating step comprises heating the supporting board to a temperature of at least about 5° C. above the crossover temperature of the adhesive.

3. The method of claim 2, wherein the heating step comprises heating the supporting board to a temperature of at most about 60° C. above the crossover temperature of the adhesive.

4. The method of claim 1, wherein the adhesive is heated to a temperature to provide a viscosity of at least about 500 cPs.

5. The method of claim 1, wherein the supporting board comprises a landing segment and a conveying segment, wherein the landing segment and the conveying segment form an obtuse angle and provide a conveying path for the permeable substrate.

6. The method of claim 5, wherein the conveying segment comprises folding arms for causing the permeable substrate to fold over on itself to provide a laminate.

7. The method of claim 6, wherein the permeable substrate is a nonwoven substrate and the method further comprises positioning an elastic strand on the nonwoven substrate at a location corresponding to the fold line.

8. The method of claim 1, wherein the supporting board is metal.

9. The method of claim 1 further comprising monitoring the temperature of the supporting board during operation and applying heat or a cooling medium to control the temperature of the supporting board.

10. The method of claim 9, wherein the step of applying heat or cooling medium comprises controlling the temperature of the supporting board to a temperature of at least about 5° C. above the crossover temperature of the adhesive.

11. The method of claim 1, wherein the hot melt adhesive is polyolefin-based.

12. (canceled)

13. The method of claim 1, wherein the permeable substrate is a nonwoven substrate or a formed film having small holes.

14. The method of claim 1, wherein the hot melt adhesive is applied at an add-on level of from about 0.5 to about 175 grams per square meter.

15. The method of claim 1, wherein the heating step is done prior to start-up of operation of the system.

16. The method of claim 1 further comprising conveying the permeable substrate with the hot melt adhesive applied, after it has contacted the supporting board, to a nip roller, wherein the nip roller is heated to a temperature sufficient to at least significantly reduce build-up of adhesive on the nip roller.

17. The method of claim 16, wherein the nip roller is heated to a temperature of at least about 30° C. below the crossover temperature of the adhesive and at most about 30° C. above the crossover temperature of the adhesive.

18. The method of claim 17 further comprising monitoring the temperature of the nip roller during operation and applying heat or a cooling medium to control the temperature of the nip roller.

19. (canceled)

20. A system for applying a hot melt adhesive to a substrate comprising:
a plurality of rollers for conveying the substrate;
an adhesive applicator for applying the adhesive to the substrate;
a supporting board for providing a conveying path for the substrate after the adhesive has been applied to the substrate; and
a heater for providing heat to the supporting board.

21. The system of claim 20 further comprising a chiller for cooling the supporting board.

22. The system of claim 21 further comprising a sensor for sensing the temperature of the supporting board and a heat control system for transferring heat among the heater, the chiller, and the supporting board to maintain the temperature of the supporting board between at least about 5° C. above and at most 60° C. above the crossover temperature of the adhesive.
